(19) United States
(12) Patent Application Publication
(10) Pub. No.: US 2026/0146303 A1
(43) Pub. Date: May 28, 2026

(54) METHOD FOR RECOVERING LITHIUM WITH HIGH EFFICIENCY FROM LOW-GRADE LITHIUM MINERALS THROUGH PROCESS IMPORVEMENT, AND LITHIUM CARBONATE PREPARED THEREBY

(71) Applicant: Korea Institute Of Geoscience And Mineral Resources, Daejeon (KR)

(72) Inventors: Taegong RYU, Daejeon (KR); Han Kwon CHANG, Daejeon (KR); Junho SHIN, Daejeon (KR); Jae-Min JEONG, Daejeon (KR); Byung-Su KIM, Wanju-gun (KR); Sun Kyung KIM, Daejeon (KR); Tae Jun PARK, Daejeon (KR)

(73) Assignee: Korea Institute Of Geoscience And Mineral Resources, Daejeon (KR)

(21) Appl. No.: 19/121,738

(22) PCT Filed: Nov. 14, 2023
(86) PCT No.: PCT/KR2023/018229

§ 371 Date: Apr. 16, 2025

(30) Foreign Application Priority Data
Nov. 14, 2022 (KR) 10-2022-0152033
Nov. 10, 2023 (KR) 10-2023-0155152

(51) Int. Cl. C22B 26/12; C01D 15/08; C22B 1/06; C22B 3/12

(52) U.S. Cl. CPC C22B 26/12; C01D 15/08; C22B 1/06; C22B 3/12

(57) ABSTRACT

The present invention provides: a method for recovering lithium with high efficiency from low-grade lithium minerals through process improvement, whereby a process for recovering lithium from lithium-containing minerals by acid-roasting, heat-treating, water-leaching, and refining lithium-containing minerals can be improved and optimum process conditions can be derived to suppress the incorporation of impurities such as aluminum and thereby increase the rate of lithium ion recovery in a lithium component separation process; and lithium carbonate prepared thereby.

### TECHNICAL FIELD

The present disclosure relates to a method for recovering lithium with high efficiency from low-grade lithium minerals through process improvement and lithium carbonate prepared thereby. In particular, the present disclosure relates to a method for recovering lithium with high efficiency from low-grade lithium minerals through process improvement and lithium carbonate prepared thereby, which aim to improve the process of recovering lithium from lithium-containing minerals by performing acid-roasting, heat-treating, water-leaching, and refining. By deriving optimum process conditions and suppressing the incorporation of impurities such as aluminum, the lithium ion recovery rate can be enhanced during the lithium separation process.

### BACKGROUND ART

As the markets for electric vehicles (EVs) and energy storage systems (ESS) are rapidly expanding, the demand for lithium compounds used as raw materials for lithium-ion battery cathode materials is also increasing significantly.

Currently, commercially viable lithium resources are limited to high-grade minerals and brine deposits, leading to a growing need for the development of recovery technologies for low-grade lithium resources.

The process of leaching lithium from low-grade lithium-containing minerals generally involves several steps. First, calcination is performed to induce a phase transition in the minerals, altering their crystal structure to facilitate lithium extraction. Next, acid-roasting is carried out to convert the lithium within the minerals into an extractable form. Subsequently, lithium is leached from the treated minerals to obtain a lithium-containing leachate, which is then subjected to purification. In these methods, lithium-containing minerals are roasted in the presence of acids such as sulfuric acid, producing acid-roasted lithium-containing materials. The lithium from these materials is then recovered by converting them into lithium carbonate or similar forms.

However, when dealing with low-grade lithium-containing minerals with a lithium content of 1.5 wt % or less, the conventional acid-roasting/water-leaching method suffers from low lithium recovery rates. If multiple cycles of acid-roasting/water-leaching are applied to improve recovery, significant lithium losses occur during the separation process due to water retention (hydration loss) in the leachate, leading to a high overall lithium loss rate.

In addition, when the lithium content is low, the lithium solution recovered through acid leaching or acid-roasting/water-leaching has a low ion concentration. This results in high energy consumption during the production of the high-concentration lithium solution required for lithium carbonate synthesis. Furthermore, multi-stage concentration processes may be required, making the process more complex and increasing operational costs, ultimately leading to a rise in product prices.

### DISCLOSURE

### Technical Problem

In order to solve the aforementioned problems, a purpose of the present disclosure is to provide a method for recovering lithium from low-grade lithium-containing minerals with low lithium content, while suppressing the incorporation of impurities, particularly aluminum, and enhancing the lithium ion recovery rate during repeated lithium separation processes.

The challenges that the present disclosure is intended to solve are not limited to those mentioned above, and other challenges not mentioned will be apparent to those skilled in the art from the following description.

### Technical Solution

In order to achieve the purpose, an aspect of the present disclosure provides a method for recovering lithium with high efficiency from low-grade lithium minerals through process improvement, the method comprising:
a step (S10) for acid-roasting a lithium-containing mineral to form an acid-roasted conversion product that is an oxide of constituent metal of the lithium-containing mineral;
a step (S20) for heat-treating the acid-roasted conversion product;
a step (S30) for water-leaching the heat-treated acid-roasted conversion product to prepare a lithium-containing water-leaching solution;
a step (S40) for adding an alkali solvent to the lithium-containing water-leaching solution to precipitate and remove impurities, wherein the impurities includes Al, Mg, Fe, Mn, and Si, while excluding lithium; and
a step (S50) for preparing at least one selected from a group consisting of lithium phosphate, lithium sulfate, and lithium carbonate, from the lithium-containing water-leaching solution removed of the impurities.

In some exemplary embodiments, the method may further comprise a step for calcining the lithium-containing mineral at a temperature of 850° C. to 1200° C. for 30 to 90 minutes, before acid-roasting the lithium-containing mineral.

In some exemplary embodiments, the lithium-containing mineral may have a lithium content ranging from 0.1 wt % to 1.5 wt %.

In some exemplary embodiments, the lithium-containing mineral may include at least one selected from a group consisting of low-grade lepidolite and spodumene.

In other words, the lithium-containing mineral may include low-grade lepidolite or low-grade spodumene or both thereof.

In some exemplary embodiments, the step (S10) may comprise:
mixing the lithium-containing mineral with a sulfuric acid solution having a concentration of 5 M to 7 M or 11 M to 12 M, such that a mass ratio (g/L) of the lithium-containing mineral to the sulfuric acid solution ranges from 800 to 1200; and after drying, performing sulfuric acid-roasting at a temperature of 200° C. to 500° C. for 10 to 60 minutes.

In some exemplary embodiments, in the step (S20), the acid-roasted conversion product is heat-treated at a temperature of 500° C. to 900° C. for 1 to 7 hours, thereby converting an aluminum sulfate component formed after the acid-roasting into an aluminum hydroxide component or an aluminum oxide component, to suppress incorporation into a leachate during the water-leaching.

In some exemplary embodiments, in the step (S30), a mass ratio (g/L) of the heat-treated acid-roasted conversion product to water may range from 50 to 700.

In some exemplary embodiments, the alkali solvent may include at least one selected from a group consisting of sodium hydroxide, calcium hydroxide, and potassium hydroxide.

In some exemplary embodiments, in the step (S40), the calcium hydroxide may be added to the lithium-containing water-leaching solution such that a mass ratio (g/L) of the calcium hydroxide to the lithium-containing water-leaching solution ranges from 8 to 25.

In some exemplary embodiments, in the step (S40), a sodium hydroxide solution may be added to the lithium-containing water-leaching solution to adjust pH to a range of 7 to 11.

In some exemplary embodiments, the step (S50) may comprise:
a step (S51) for preparing lithium phosphate from the lithium-containing water-leaching solution removed of the impurities;
a step (S52) for preparing a lithium sulfate solution from the lithium phosphate; and a step (S53) for preparing lithium carbonate from the lithium sulfate solution.

In some exemplary embodiments, in the step (S51), a phosphate source and a sodium source may be added to the lithium-containing water-leaching solution such that Li/PO₄ and Na/PO₄ molar ratios each range from 2 to 4, and the reaction may be carried out for 10 to 30 hours.

In some exemplary embodiments, in the step (S52), the lithium phosphate may be mixed with a sulfate compound (Me-SO₄) solution dissolved in distilled water such that a mass ratio (g/L) of the lithium phosphate to the sulfate compound (Me-SO₄) solution ranges from 80 to 250, and the reaction may be carried out at a temperature of 60° C. to 95° C. for 5 to 10 hours.

In some exemplary embodiments, the sulfate compound may include at least one selected from a group consisting of magnesium sulfate (MgSO₄), ammonium sulfate ((NH₄)₂SO₄), and aluminum sulfate (Al₂(SO₄)₃).

In some exemplary embodiments, in the step (S52), the aluminum sulfate (Al₂(SO₄)₃) may be dissolved in distilled water to adjust Li/Al molar ratio to a range of 0.317 to 0.367.

In some exemplary embodiments, the step (S53) may comprise:
adding an alkali solvent to the lithium sulfate solution to remove impurities; and
adding a carbonate source to the lithium sulfate solution removed of the impurities to recover lithium carbonate.

In some exemplary embodiments, in the step for adding an alkali solvent to the lithium sulfate solution to remove impurities,
calcium hydroxide may be added to the lithium sulfate solution to precipitate and remove at least one selected from Al and PO₄, and
sodium hydroxide may be added to adjust pH to 10 or higher to remove calcium ions.

In some exemplary embodiments, in the step for adding a carbonate source to the lithium sulfate solution removed of the impurities to recover lithium carbonate,
the carbonate source may be added to the lithium sulfate solution removed of the impurities such that Li/CO₃ molar ratio ranges from 1.5 to 2.5, and
the lithium sulfate solution removed of the impurities may be stirred at a temperature of 50° C. to 70° C. for 6 to 10 hours to precipitate lithium carbonate.

In some exemplary embodiments, the carbonate source may include at least one selected from a group consisting of sodium carbonate (Na₂CO₃), sodium bicarbonate (NaHCO₃), potassium carbonate (K₂CO₃), potassium bicarbonate (KHCO₃), calcium carbonate (CaCO₃), magnesium carbonate (MgCO₃), and barium carbonate (BaCO₃).

In order to achieve the purpose, another aspect of the present disclosure provides lithium carbonate prepared by the method for method for recovering lithium with high efficiency from low-grade lithium minerals through process improvement.

### Advantageous Effects

The method for recovering lithium with high efficiency from low-grade lithium-containing minerals according to the present disclosure improves the process of lithium recovery by performing acid-roasting, heat treatment, water leaching, and purification. By deriving optimum process conditions and suppressing the incorporation of impurities, the method enhances the lithium ion recovery rate during the lithium separation process, thereby enabling the efficient recovery of lithium from low-grade lithium-containing minerals.

The effects of the present disclosure are not limited to the aforementioned effects and should be understood to include all effects that can be inferred from the configurations of the present disclosure described in the detailed description or the claims.

### DESCRIPTION OF DRAWINGS

FIG. 1 is a process flowchart illustrating a high-efficiency lithium recovery method from low-grade lithium minerals according to an exemplary embodiment of the present disclosure.

FIG. 2 is a TGA/DTA graph analyzing the thermal properties of lepidolite concentrate powder according to an exemplary embodiment of the present disclosure.

FIG. 3 is a graph showing changes in the XRD pattern depending on lepidolite phase and calcination temperature according to an exemplary embodiment of the present disclosure.

FIG. 4 is a graph showing changes in lithium ion concentration during acid roasting/water leaching, depending on the molar concentration of the sulfuric acid solution, according to an exemplary embodiment of the present disclosure.

FIG. 5 is a graph showing changes in lithium ion concentration during acid roasting/water leaching, depending on the calcination temperature of lepidolite, according to an exemplary embodiment of the present disclosure.

FIG. 6 is a graph showing changes in lithium ion concentration during water leaching of acid-roasted lepidolite conversion products, depending on the solid (conversion product, g)/liquid (water, L) ratio, according to an exemplary embodiment of the present disclosure.

FIG. 7 is a graph showing changes in impurity content in a lithium-containing water-leaching solution prepared from lepidolite, depending on the amount of Ca(OH)₂ added, according to an exemplary embodiment of the present disclosure.

FIG. 8 is an XRD pattern of lithium phosphate prepared from a reaction between lithium extraction solution and a NaOH/H₃PO₄ mixed solution, according to an exemplary embodiment of the present disclosure.

FIG. 9 is an XRD pattern of lithium carbonate produced through the purification and carbonation reaction of lithium phosphate sulfuric acid leachate, according to an exemplary embodiment of the present disclosure.

FIG. 10 is a graph showing changes in leachate ion concentration during water leaching, depending on the heat treatment temperature of acid-roasted lepidolite conversion products, according to an exemplary embodiment of the present disclosure.

FIG. 11 is a graph showing changes in lithium ion concentration during repeated water leaching, depending on the post-treatment process of acid-roasted lepidolite conversion products, according to an exemplary embodiment of the present disclosure.

FIG. 12 is a graph showing changes in lithium and aluminum ion concentrations during water leaching, depending on the solid/liquid ratio of acid-roasted lepidolite conversion products and the post-treatment process during leaching, according to an exemplary embodiment of the present disclosure.

FIG. 13 is a graph showing the component distribution of the water-leaching solution after adding NaOH to the water-leached acid-roasted lepidolite conversion product, depending on the pH of the leachate, according to an exemplary embodiment of the present disclosure.

FIG. 14 is a graph showing the component distribution of the water-leaching solution after adding Ca(OH)₂, depending on the amount of Ca(OH)₂ added (solid/liquid ratio), following the water leaching of acid-roasted lepidolite conversion products, according to an exemplary embodiment of the present disclosure.

FIG. 15 is a graph showing the ion distribution in the lithium sulfate solution produced at different Al/Li molar ratios during the conversion reaction between lithium phosphate and an Al₂(SO₄)₃ aqueous solution, according to an exemplary embodiment of the present disclosure.

FIG. 16 is an XRD pattern of the precipitate obtained after the carbonation reaction, according to an exemplary embodiment of the present disclosure.

### MODE FOR INVENTION

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

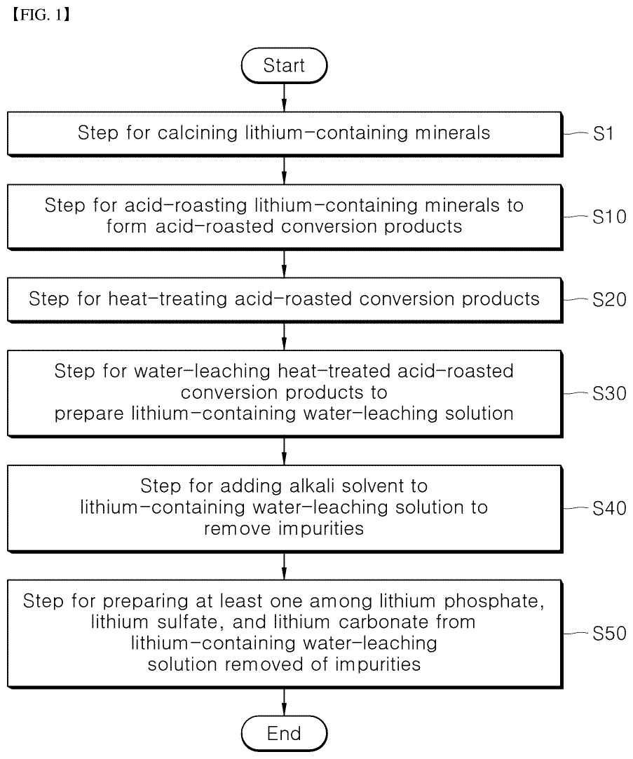

According to an exemplary embodiment of the present disclosure, as shown in the process flowchart of FIG. 1, a method for recovering lithium with high efficiency from low-grade lithium minerals through process improvement is provided, the method comprising:
a step (S10) for acid-roasting a lithium-containing mineral to form an acid-roasted conversion product that is an oxide of constituent metal of the lithium-containing mineral;
a step (S20) for heat-treating the acid-roasted conversion product;
a step (S30) for water-leaching the heat-treated acid-roasted conversion product to prepare a lithium-containing water-leaching solution;
a step (S40) for adding an alkali solvent to the lithium-containing water-leaching solution to precipitate and remove impurities, wherein the impurities includes Al, Mg, Fe, Mn, and Si, while excluding lithium; and
a step (S50) for preparing at least one selected from a group consisting of lithium phosphate, lithium sulfate, and lithium carbonate, from the lithium-containing water-leaching solution removed of the impurities.

In an exemplary embodiment of the present disclosure, the lithium-containing mineral may include at least one selected from a group consisting of low-grade spodumene, petalite, and lepidolite.

Here, “low-grade” may refer to a lithium content of 1.5 wt % or less, and more specifically, 1 wt % or less.

As a specific example, the lithium-containing mineral may include at least one selected from a group consisting of low-grade lepidolite and low-grade spodumene. In particular, the lithium-containing mineral may be low-grade lepidolite.

The lepidolite may contain lithium (Li), magnesium (Mg), aluminum (Al), calcium (Ca), and silicon (Si). Here, the content of Lithium (Li): 0.1 wt % to 1, the content of Magnesium (Mg) may be 0.01 wt % to 2 wt %, the content of Aluminum (Al) may be 5 wt % to 15 wt %, the content of Calcium (Ca) may be 10 wt % to 17 wt %, and the content of Silicon (Si) may be 12 wt % to 20 wt %.

In an exemplary embodiment of the present disclosure, the lithium-containing mineral may have a lithium content of 0.1 wt % to 1.5 wt %, 0.1 wt % to 0.8 wt %, or 0.2 wt % to 0.6 wt %. In the case of such low-grade lithium-containing minerals, the conventional acid-roasting/water-leaching method results in a low lithium recovery rate. Furthermore, if repeated acid-roasting/water-leaching cycles are applied, significant lithium loss occurs due to water retention (hydration loss) during the solution separation process after water leaching, leading to a high lithium loss rate in the recovery process.

In addition, when the lithium content is low, the ion concentration in the recovered lithium solution obtained through acid leaching or acid-roasting/water-leaching is also low. As a result, in the process of producing lithium carbonate, the high-concentration lithium solution required for synthesis demands high energy consumption during concentration or necessitates a multi-stage concentration process, making the procedure more complex and increasing process costs. This, in turn, leads to an increase in product prices.

In order to solve out the conventional problems, the present disclosure aims to provide a method for efficiently recovering lithium from low-grade lithium-containing minerals with a lithium content of 1.5 wt % or less by improving the process and deriving optimal process conditions to enhance lithium recovery efficiency.

In an exemplary embodiment of the present disclosure, before acid-roasting the lithium-containing mineral, the method may further comprise a step (S1) for calcining the lithium-containing mineral.

For example, the lithium-containing mineral may be calcined at a temperature of 850° C. to 1200° C. for 30 to 90 minutes.

As a specific example, the calcination step may be performed by heating the lithium-containing mineral at a temperature of 900° C. to 1150° C. or 1000° C. to 1100° C. for 30 to 80 minutes or 50 to 70 minutes.

When the lithium-containing mineral is calcined under the above-specified conditions, the lithium-containing mineral in an alpha (α) structure can be converted to the lithium-containing mineral in a beta (β) structure. Specifically, during calcination, the decomposition reaction of limestone (CaCO₃) present in the lithium-containing mineral occurs, leading to the formation of CaO (calcium oxide). As a result, this process induces weight reduction and phase transition depending on the calcination temperature.

In an exemplary embodiment of the present disclosure, the step S10 may involve acid-roasting the lithium-containing mineral to form acid-roasted conversion products. The acid-roasting may be performed by mixing the lithium-containing mineral with an acid solution, drying a mixture of the lithium-containing mineral and the acid solution, and then heating the mixture.

The acid solution may include, for example, a sulfuric acid solution.

In an exemplary embodiment of the present disclosure, the step (S10) may comprise:
mixing the lithium-containing mineral with a sulfuric acid solution having a concentration of 5 M to 7 M or 11 M to 12 M, such that a mass ratio (g/L) of the lithium-containing mineral to the sulfuric acid solution ranges from 800 to 1200; and
after drying, performing sulfuric acid-roasting at a temperature of 200° C. to 500° C. for 10 to 60 minutes, thereby to form the acid-roasted conversion products.

In a specific example, the step (S10) may comprise:
mixing the lithium-containing mineral with a sulfuric acid solution having a concentration of 5 M to 7 M or 11 M to 12 M, such that a mass ratio (g/L) of the lithium-containing mineral to the sulfuric acid solution ranges from 900 to 1100 or from 950 to 1050; and
after drying, performing sulfuric acid-roasting at a temperature of 200° C. to 400° C. for 20 to 40 minutes.

When the lithium-containing mineral undergoes sulfuric acid roasting under the specified conditions as above, it can increase the lithium ion concentration during water leaching while minimizing the incorporation of other metal ions that react with sulfuric acid to form sulfate compounds.

In an exemplary embodiment of the present disclosure, in the step (S20), the acid-roasted conversion product may be heat-treated at a temperature of 500° C. to 900° C. for 1 to 7 hours, thereby converting an aluminum sulfate component formed after the acid-roasting into an aluminum hydroxide component or an aluminum oxide component, to suppress incorporation into a leachate during the water-leaching.

The present disclosure relates to a high-efficiency lithium recovery method from low-grade lithium minerals through process improvement. In the process of extracting and recovering lithium from low-grade lithium minerals with low lithium content, the most critical aspect may be minimizing lithium loss.

Accordingly, by subjecting the acid-roasted conversion products to subsequent heat treatment, the aluminum sulfate component formed after acid roasting can be converted into aluminum hydroxide or aluminum oxide, thereby suppressing its incorporation into the leachate during water leaching. This can significantly reduce lithium loss.

In an exemplary embodiment of the present disclosure, in the step (S20), the acid-roasted conversion product may be heat-treated at a temperature of 500° C. to 900° C. for 1 to 7 hours, thereby converting an aluminum sulfate component formed after the acid-roasting into an aluminum hydroxide component or an aluminum oxide component, to suppress incorporation into a leachate during the water-leaching.

As a specific example, in the step (S20), the acid-roasted conversion product may be heat-treated at a temperature of 600° C. to 800° C. or 650° C. to 750° C. for 1 to 7 hours, 3 to 6 hours, or 3 to 5 hours.

When the acid-roasted conversion products undergo heat treatment under the specified conditions before water leaching, it is possible to increase the lithium ion concentration in the leachate while suppressing the incorporation of aluminum components, thereby enhancing the lithium recovery rate.

In addition, heat-treating the acid-roasted conversion products under these conditions allows the aluminum sulfate component formed after acid roasting to be converted into aluminum hydroxide or aluminum oxide, thereby preventing its incorporation into the leachate during water leaching.

In an exemplary embodiment of the present disclosure, the step (S30) may involve water-leaching the heat-treated acid-roasted conversion product to prepare a lithium-containing water-leaching solution.

In an exemplary embodiment of the present disclosure, in the step (S30), a mass ratio (g/L) of the heat-treated acid-roasted conversion product to water may be adjusted to range from 50 to 700.

As a specific example, the step (S30) may be performed by adjusting the mass ratio (g/L) of the heat-treated acid-roasted conversion products to water to be 50 to 700, 100 to 600, or 100 to 500.

The step (S30) may be performed once, 2 to 20 times, or 5 to 10 times. While repeated leaching may lead to lithium loss during the recovery process, the present disclosure prevents such losses by performing heat treatment prior to the water-leaching step.

The water-leaching process may be conducted under stirring conditions, where the stirring speed can be adjusted to 100 to 500 rpm, 200 to 400 rpm, or 250 to 350 rpm.

The water-leaching process may be carried out at a temperature of 15° C. to 30° C., 20° C. to 30° C., or 20° C. to 25° C., for a duration time of 12 to 30 hours or 20 to 25 hours.

As described above, by performing acid roasting, heat treatment, and subsequent water leaching on low-grade lithium-containing minerals, the lithium ion concentration in the leachate may be increased while significantly reducing the incorporation of Al, Si, and Fe components into the water leachate.

In an exemplary embodiment of the present disclosure, the step (S40) may be a purification step for adding an alkali solvent to the lithium-containing water-leaching solution to precipitate and remove impurities.

The alkali solvent may include at least one selected from a group consisting of sodium hydroxide, calcium hydroxide, and potassium hydroxide. As a specific example, the alkali solvent may be calcium hydroxide.

The impurity removal process may be conducted under stirring conditions, where the stirring speed can be adjusted to 100 to 500 rpm, 200 to 400 rpm, or 250 to 350 rpm.

In addition, the impurity removal process may be performed at a temperature of 15° C. to 30° C., 20° C. to 30° C., or 20° C. to 25° C., for a duration time of 12 to 30 hours or 20 to 25 hours.

In an exemplary embodiment of the present disclosure, in the step (S40), the calcium hydroxide may be added to the lithium-containing water-leaching solution such that a mass ratio (g/L) of the calcium hydroxide to the lithium-containing water-leaching solution ranges from 8 to 25 or from 10 to 17.

In an exemplary embodiment of the present disclosure, in the step (S40), a sodium hydroxide solution may be added to the lithium-containing water-leaching solution to adjust pH to a range of 7 to 11.

When adding an alkali solvent to the lithium-containing water-leaching solution, the impurity removal process can be carried out under the above specified conditions to effectively remove impurities such as Al, Mg, Fe, Mn, and Si, while minimizing lithium loss and efficiently separating Al components.

In an exemplary embodiment of the present disclosure, the step (S50) may involve preparing at least one selected from a group consisting of lithium phosphate, lithium sulfate, and lithium carbonate, from the lithium-containing water-leaching solution removed of the impurities.

As a specific example, the step (S50) may comprise:
a step (S51) for preparing lithium phosphate from the lithium-containing water-leaching solution removed of the impurities;
a step (S52) for preparing a lithium sulfate solution from the lithium phosphate; and
a step (S53) for preparing lithium carbonate from the lithium sulfate solution.

In particular, in an exemplary embodiment of the present disclosure, lithium phosphate (Li₃PO₄), an insoluble lithium compound, was produced as an intermediate to convert the lithium-containing water-leaching solution (from which impurity ions have been removed) into a high-concentration lithium solution required for lithium carbonate production.

The insoluble lithium compound with low solubility may include at least one selected from Li—Al LDH(LiAl₂(OH)₇·2H₂O) and Li₃PO₄. However, since Li—Al LDH contains only 3.21 wt % lithium per unit weight (g), while lithium phosphate contains approximately 17.98 wt % lithium, lithium phosphate is preferable as an intermediate compound for producing high-concentration lithium solutions.

Meanwhile, although Li—Al LDH is not suitable for high-concentration lithium solution production due to its low lithium content and low density, it has significantly lower solubility than lithium phosphate, making it ideal for efficient lithium ion separation from solutions with lithium ion concentrations of 1000 ppm or lower. Furthermore, Li—Al LDH can undergo a sulfurization reaction to be converted into a solution with a lithium ion concentration of 2000 ppm or higher, making it applicable as a raw material for lithium phosphate production.

In an exemplary embodiment of the present disclosure, in the step (S51), a phosphate source and a sodium source may be added to the lithium-containing water-leaching solution such that Li/PO₄ and Na/PO₄ molar ratios each range from 2 to 4, and the reaction may be carried out for 10 to 30 hours.

As a specific example, in the step (S51), a phosphate source and a sodium source may be added to the lithium-containing water-leaching solution such that Li/PO₄ and Na/PO₄ molar ratios each range from 2.5 to 3.5, and the reaction may be carried out for 22 to 25 hours.

The phosphate source may include phosphoric acid (H₃PO₄) or phosphate salts. The phosphate salts may include at least one selected from a group consisting of potassium phosphate, sodium phosphate, aluminum phosphate, zinc phosphate, ammonium polyphosphate, and sodium hexametaphosphate. As a specific example, the phosphate source may be phosphoric acid (H₃PO₄).

The sodium source may include at least one selected from a group consisting of sodium hydroxide, sodium phosphate, and sodium hexametaphosphate. As a specific example, the sodium source may be sodium hydroxide.

In an exemplary embodiment of the present disclosure, in the step (S52), the lithium phosphate may be mixed with a sulfate compound (Me-SO₄) solution dissolved in distilled water such that a mass ratio (g/L) of the lithium phosphate to the sulfate compound (Me-SO₄) solution ranges from 80 to 250, and the reaction may be carried out at a temperature of 60° C. to 95° C. for 5 to 10 hours.

As a specific example, in the step (S52), the lithium phosphate may be mixed with a sulfate compound (Me-SO₄) solution dissolved in distilled water such that a mass ratio (g/L) of the lithium phosphate to the sulfate compound (Me-SO₄) solution ranges from 100 to 220, and the reaction may be carried out at a temperature of 75° C. to 85° C. for 7 to 9 hours.

The sulfate compound may include at least one selected from a group consisting of magnesium sulfate (MgSO₄), ammonium sulfate ((NH₄)₂SO₄), and aluminum sulfate (Al₂(SO₄)₃). As a specific example, the sulfate compound may be Al₂(SO₄)₃. By using sulfate compounds in a substitution reaction to produce a lithium sulfate solution from lithium phosphate, a high-concentration lithium sulfate solution can be obtained.

During the process of dissolving the sulfate compound in distilled water and mixing it with lithium phosphate for reaction, in order to prevent the evaporation of distilled water, the conversion reaction may be carried out using a reflux reactor.

The step (S52) may be performed under stirring conditions, where the stirring speed can be adjusted to 100 to 500 rpm, 200 to 400 rpm, or 250 to 350 rpm.

In the step (S52), the aluminum sulfate (Al₂(SO₄)₃) may be dissolved in distilled water to adjust Li/Al molar ratio to a range of 0.317 to 0.367, 0.321 to 0.350, or 0.325 to 0.350. In this case, a lithium sulfate solution having high lithium ion concentration can be produced.

In an exemplary embodiment of the present disclosure, the step (S53) may comprise:
adding an alkali solvent to the lithium sulfate solution to remove impurities; and
adding a carbonate source to the lithium sulfate solution removed of the impurities to recover lithium carbonate.

The alkali solvent may include at least one selected from a group consisting of sodium hydroxide, calcium hydroxide, and potassium hydroxide.

In an exemplary embodiment of the present disclosure, in the step for adding an alkali solvent to the lithium sulfate solution to remove impurities,
calcium hydroxide may be added to the lithium sulfate solution to precipitate and remove at least one selected from Al and PO₄, and
sodium hydroxide may be added to adjust pH to 10 or higher to remove calcium ions.

As a specific example, in the step for adding an alkali solvent to the lithium sulfate solution to remove impurities,
calcium hydroxide may be added to the lithium sulfate solution to precipitate and remove at least one selected from Al and PO₄, and
sodium hydroxide may be added to adjust pH to 10 or higher or to 12 or higher to remove calcium ions.

Through this process, impurities can be removed additionally before lithium carbonate production, thereby increasing the purity of the lithium carbonate during manufacturing.

In an exemplary embodiment of the present disclosure, in the step for adding a carbonate source to the lithium sulfate solution removed of the impurities to recover lithium carbonate,
the carbonate source may be added to the lithium sulfate solution removed of the impurities such that Li/CO₃ molar ratio ranges from 1.5 to 2.5, and
the lithium sulfate solution removed of the impurities may be stirred at a temperature of 50° C. to 70° C. for 6 to 10 hours to precipitate lithium carbonate.

In this case, the conversion efficiency from lithium sulfate to lithium carbonate may be enhanced.

The step of recovering lithium carbonate from the lithium sulfate solution by adding a carbonate source to the purified lithium sulfate solution may be performed under stirring conditions. The stirring speed can be adjusted to 100 to 500 rpm, 200 to 400 rpm, or 250 to 350 rpm.

The carbonate source may include at least one selected from a group consisting of sodium carbonate (Na₂CO₃), sodium bicarbonate (NaHCO₃), potassium carbonate (K₂CO₃), potassium bicarbonate (KHCO₃), calcium carbonate (CaCO₃), magnesium carbonate (MgCO₃), and barium carbonate (BaCO₃). As a specific example, the carbonate source may be sodium carbonate.

In addition, the present disclosure may provide at least one selected from a group consisting of lithium phosphate, lithium sulfate, and lithium carbonate, which are produced through the high-efficiency lithium recovery method from low-grade lithium minerals via the aforementioned process improvements.

As described above, the method for recovering lithium with high efficiency from low-grade lithium minerals through process improvement according to the present disclosure has been described and illustrated in the drawings. However, the descriptions and illustrations provided herein include only the essential components necessary for understanding the present disclosure. In addition to the processes and apparatuses described and illustrated, other processes and apparatuses not explicitly described or illustrated may be appropriately applied and utilized to implement the high-efficiency lithium recovery method according to the present disclosure.

Hereinafter, exemplary embodiments will be described in detail to specifically explain the present disclosure. However, the exemplary embodiments according to the present disclosure may be modified in various forms, and the scope of the present disclosure should not be construed as being limited to the embodiments described below. The exemplary embodiments of the present disclosure are provided to more fully explain the present disclosure to those of ordinary skill in the art.

### PREPARATION EXAMPLES

### Preparation Example 1: Preparation of Lithium-Containing Mineral Used in the Preparation Examples

Lepidolite having components of Li (1.2 wt %), Mg (0.14 wt %), Al (11.09 wt %), Ca (14.02 wt %), and Si (25.37 wt %) was collected as a domestically available lithium-containing mineral. The collected mineral underwent color sorting, crushing, and grinding, and was prepared into a powder with a particle size of approximately 1 mm or less, with a total weight of 1 kg.

For the lithium recovery experiment, the powder was used without undergoing flotation separation or gravity separation processes, except for color sorting.

### Preparation Example 2: Thermal Property Evaluation of Lepidolite Powder at Different Calcination Temperatures

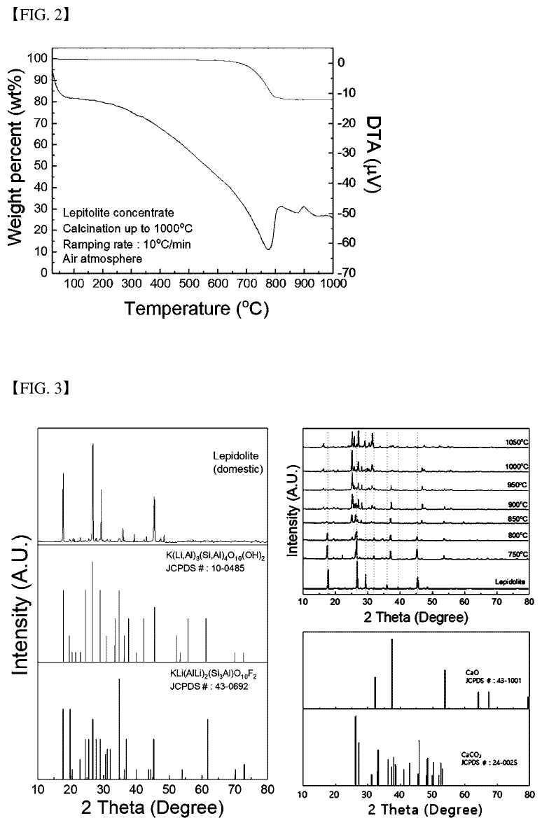

To evaluate the thermal properties of lepidolite powder (with a lithium content of approximately 1.2 wt %) under different calcination temperatures, TGA-DTA and XRD analyses were conducted. The experimental results are shown in FIG. 2 and FIG. 3, respectively.

As shown in FIG. 2, weight loss began at a calcination temperature of approximately 600° C., and a weight reduction of about 18 wt % was observed upon reaching 800° C. This weight loss is attributed to the decomposition reaction of limestone (CaCO₃) contained in the lepidolite, which was confirmed through phase transition analysis, showing the formation of CaO.

Furthermore, as shown in FIG. 3, XRD analysis of lepidolite powder under different calcination temperatures revealed CaO peaks resulting from the decomposition of CaCO₃. In addition, upon reaching 1000° C., the phase transition of the lepidolite structure was confirmed to be complete.

### Preparation Example 3: Experiment on Calcination/Acid Roasting Conditions

### 1. Experiment on Sulfuric Acid Solution Concentration

Lepidolite powder (g), which had been calcined at 1050° C. for 1 hour, was mixed with 1 M to 16 M sulfuric acid solution (L) at a solid-to-liquid ratio of 1000 g/L. The mixture was then dried and subjected to sulfuric acid roasting at 300° C. for 30 minutes.

After sulfuric acid roasting, to separate the lithium component contained in the acid-roasted conversion product, water leaching was performed at a solid-to-liquid ratio of 50 g/L, and the lithium-containing water-leaching solution was collected.

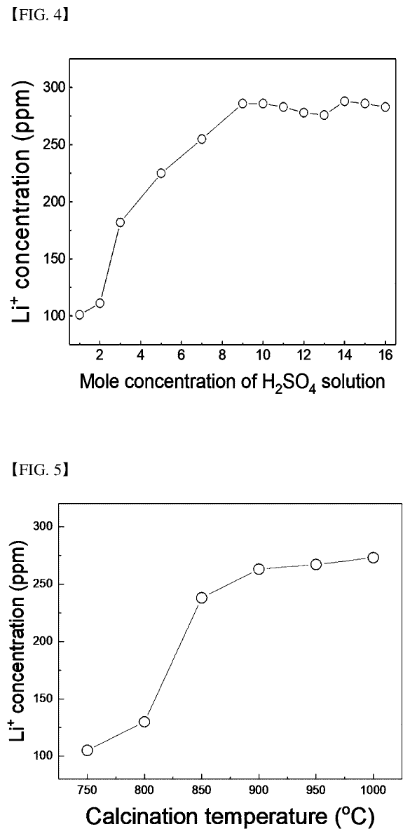

The results of the sulfuric acid roasting of lepidolite powder under different sulfuric acid molar concentrations and the corresponding lithium ion concentration changes in the water-leaching solution after leaching are shown in Table 1 and FIG. 4.

TABLE 1

| | Sulfuric | | | | Li | | |
|---|---|---|---|---|---|---|---|
| | Acid | Moles of | | | Concentration | Other | |
| | Solution | Sulfuric | | H₂SO₄/Li | After Water | Components | |
| | Concen- | Acid | Lepidolite | Molar | Leaching | (ppm) | |
| Calcination | tration | (mol#) | Usage (g) | Ratio | (ppm) | Al | Ca |
| X | 5M | 0.020 | 4.007 | 2.37 | 100 | 593 | 589 |
| 1050° C., | 1M | 0.004 | 4.007 | 0.47 | 101 | ND | 583 |
| 1 h | 2M | 0.008 | 4.009 | 0.95 | 111 | ND | 511 |
| | 3M | 0.012 | 4.007 | 1.42 | 182 | ND | 545 |
| | 5M | 0.020 | 4.001 | 2.37 | 225 | 286 | 562 |
| | 7M | 0.028 | 4.005 | 3.32 | 255 | 529 | 501 |
| | 9M | 0.036 | 4.004 | 4.26 | 286 | 1209 | 511 |
| | 10M | 0.040 | 4.006 | 4.74 | 286 | 1901 | 512 |
| | 11M | 0.044 | 4.006 | 5.21 | 283 | 230 | 526 |
| | 12M | 0.048 | 4.008 | 5.68 | 278 | 757 | 539 |
| | 13M | 0.052 | 4 | 6.17 | 276 | 1030 | 505 |
| | 14M | 0.056 | 4.007 | 6.63 | 288 | 1370 | 509 |
| | 15M | 0.060 | 4 | 7.11 | 286 | 1453 | 527 |
| | 16M | 0.064 | 4 | 7.59 | 283 | 1704 | 517 |

Referring to Table 1, it was observed that as the molar concentration of the sulfuric acid solution increased, the lithium leaching rate also increased. However, for aluminum, its incorporation into the leachate significantly increased when the sulfuric acid concentration was 5 M or higher. Meanwhile, when using 11 M sulfuric acid solution, the amount of aluminum incorporation was the lowest.

In addition, as shown in FIG. 4, when the sulfuric acid concentration increases 9 M or higher during the acid-roasting process, solidification occurs during the mixing process with lepidolite, preventing uniform mixing. Furthermore, as the sulfuric acid concentration increases, Al and other components are converted into sulfate compounds, reducing the relative lithium content in the conversion product. Consequently, the lithium ion concentration in the water-leaching solution also relatively decreases.

Moreover, Table 1 indicates that there is a significant difference in lithium separation efficiency depending on whether the material underwent prior calcination before acid roasting.

When aluminum ions coexist in the water-leaching solution, they can cause problems in subsequent separation/purification processes. During the alkali adjustment step, the formation of Li—Al LDH can occur, leading to a decrease in lithium recovery efficiency. Therefore, controlling the amount of aluminum incorporation is crucial to prevent these issues.

### 2. Experiment on Calcination Temperature

The efficiency of acid roasting of lepidolite was evaluated based on calcination temperature, with identical acid-roasting and water-leaching conditions applied to samples processed at different calcination temperatures. In particular, the solid-to-liquid ratio was controlled as follows:
Solid-to-liquid ratio of lepidolite powder (g)/11 M sulfuric acid solution (L): 1000
Solid-to-liquid ratio of acid-roasted conversion product (g)/water (L): 50

The experimental results are shown in FIG. 5.

As shown in FIG. 5, after fixing the calcination time at 30 minutes and varying the calcination temperature, the lithium ion concentration in the water-leaching solution was analyzed following acid roasting and water leaching. The results indicate that as the calcination temperature increased, the lithium ion concentration in the water-leaching solution also increased. It was confirmed that calcination at 1000° C. or higher is required to achieve optimal lithium recovery.

3. Experiment on Solid-to-Liquid Ratio (g/L) of Acid-Roasted Conversion Product to Water During Water Leaching

In the water-leaching process following calcination and acid roasting of lepidolite, the effect of the solid-to-liquid ratio (g/L) of the acid-roasted conversion product (g) to water (L) on the lithium ion concentration in the leachate was evaluated.

Since the carbonation reaction is applied to high-concentration lithium solutions to separate low-solubility lithium carbonate powder for lithium carbonate production, low-concentration lithium solutions require additional concentration steps.

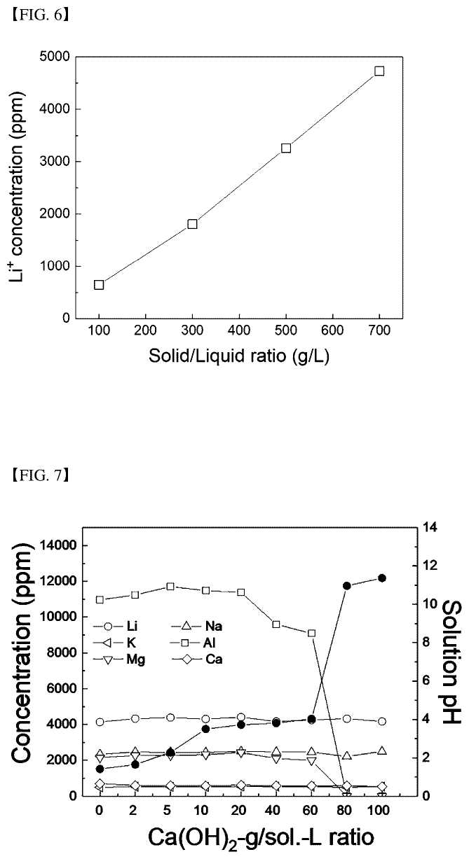

In this experiment, to prepare a high-concentration lithium solution, lepidolite powder was calcined at 1000° C. for 30 minutes, then mixed with 11 M sulfuric acid at a solid-to-liquid ratio of 1000 g/L, and dried and subjected to acid roasting at 300° C. for 30 minutes. Subsequently, water leaching was performed while adjusting the solid-to-liquid ratio (g/L) of the acid-roasted conversion product (g) to water (L). The results are shown in FIG. 6.

As shown in FIG. 6, the experimental results indicate that as the solid-to-liquid ratio (g/L) of the acid-roasted conversion product (g) to water (L) increases, the lithium ion concentration in the leachate increases linearly. However, the concentration of impurities such as Al and Mg in the leachate also increases.

In the case of lithium solution prepared under the condition where a solid-to-liquid ratio of the acid-roasted conversion product (g) to water (L) is 700 g/L, the lithium ion concentration in the solution was observed to be approximately 4700 ppm. However, when the solid-to-liquid ratio increases up to 700 g/L or higher, the viscosity of the leaching solution increased, resulting in a decrease in lithium ion separation efficiency. In addition, it was observed that after solution separation, water retention in the residue led to an increase in lithium loss during recovery.

Furthermore, as the solid-to-liquid ratio increased, the aluminum content in the leachate also increased, promoting the formation of Li—Al LDH, an insoluble lithium compound, which further contributed to lithium ion loss.

### Preparation Example 4: Purification Experiment of Lithium-Containing Water-Leaching Solution

In the lithium carbonate production process, when divalent metal ions such as Ca and Mg coexist in the lithium-containing water-leaching solution, they can cause contamination during the carbonation reaction. To remove these divalent impurity components, a pH adjustment method was considered. An experiment was conducted to remove divalent components by adding alkali solvents such as sodium hydroxide and calcium hydroxide.

### 1. Purification Using Sodium Hydroxide (NaOH)

To evaluate the impurity ion separation trend based on NaOH addition, lepidolite powder was calcined at 1050° C. for 1 hour. Afterwards, the calcined powder was mixed with 8 M sulfuric acid solution under the condition where the solid-to-liquid ratio of the powder (g) to the sulfuric acid solution (L) is 1000 g/L, dried, and then acid-roasted at 300° C. for 30 minutes. Subsequently, the acid-roasted conversion product was subjected to water leaching under the condition where the solid-to-liquid ratio of the acid-roasted conversion product (g) to water (L) is 50 g/L. The experimental results are shown in Table 2.

TABLE 2

| | |
|---|---|
| Solution | Concentration (ppm) |

| pH | Li | Al | Mg | Ca |
|---|---|---|---|---|
| initial | 275 | 686 | 43.5 | 402.5 |
| 6.73 | 262 | 65 | 41 | 247 |
| 9.12 | 241 | 12 | 18.5 | 24 |
| 10.5 | 242 | 40 | 4.5 | 15.5 |

Referring to Table 2, it was observed that when the sodium hydroxide was added, the impurity content decreased as the solution pH increased. However, the lithium content also decreased. Furthermore, when the solution pH exceeded 10, the separated Al was redissolved, leading to an increase in its concentration.

### 2. Purification Using Calcium Hydroxide (Ca(OH)₂)

To evaluate the impurity ion separation trend based on Ca(OH)₂ addition, lepidolite powder was calcined at 1050° C. for 1 hour. Afterwards, the calcined powder was mixed with 11 M sulfuric acid solution under the condition where the solid-to-liquid ratio of the powder (g) to the sulfuric acid solution (L) is 1000 g/L, dried, and then acid-roasted at 300° C. for 30 minutes. Subsequently, the acid-roasted conversion product was subjected to water leaching under the condition where the solid-to-liquid ratio of the acid-roasted conversion product (g) to water (L) is 700 g/L. The experimental results are shown in FIG. 7.

As the calcium hydroxide was added, when the solution pH increased to approximately 10.9, Al and Mg ions were removed. Compared to the results using NaOH, the lithium content loss was slight.

### Preparation Example 5: Conversion of Lithium-Containing Water-Leaching Solution to Lithium Phosphate

The production of lithium carbonate from a lithium-containing water-leaching solution is typically carried out through a carbonation reaction using CO₂(g) or sodium carbonate (Na₂CO₃). This method exploits differences in solubility to precipitate lithium carbonate.

The lithium-containing water-leaching solution, after the removal of impurity ions (Mg, Al), had a lithium ion concentration of approximately 4,370 ppm. To convert it into a high-concentration lithium solution required for lithium carbonate production, an insoluble lithium compound, lithium phosphate (Li₃PO₄), was produced as an intermediate material.

To achieve this, lepidolite powder was calcined at 1050° C. for 1 hour, then mixed with 11 M sulfuric acid solution at a solid-to-liquid ratio of power (g) to sulfuric acid solution (L) of 1000 g/L, dried, and acid-roasted at 300° C. for 30 minutes. Next, the acid-roasted conversion product was subjected to water leaching at a solid-to-liquid ratio of acid-roasted conversion product (g) to water (L) of 700 g/L to obtain a lithium-containing water-leaching solution. For the production of lithium phosphate, a mixture of sodium hydroxide and phosphoric acid (H₃PO₄) was added to the lithium-containing water-leaching solution under the conditions of Li/PO₄, NaOH/H₃PO₄ molar ratio of 3, and the reaction was carried out for 24 hours, leading to the precipitation of lithium phosphate.

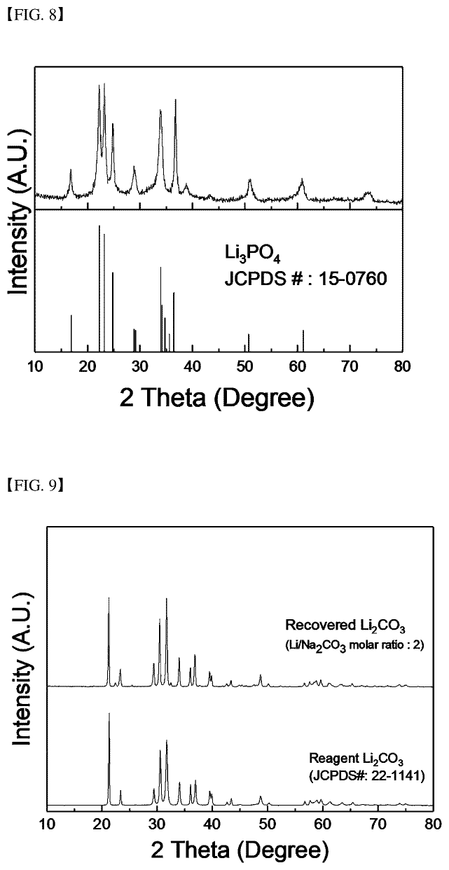

Next, the lithium ion content in the initial lithium-containing water-leaching solution and the filtrate after lithium phosphate conversion was measured. The results are shown in Table 3 and FIG. 8.

TABLE 3

Content (ppm)

| | Li | Na | K | Ca |
|---|---|---|---|---|
| Initial | 4370 | 2488 | 495 | 571 |
| Final | 348 | 11890 | 503 | — |

As a result, after lithium phosphate conversion, the lithium ion concentration in the filtrate decreased from approximately 4,370 ppm to 348 ppm, as confirmed by ICP analysis. The formation of lithium phosphate led to a lithium ion recovery rate of approximately 92 wt %.

### Preparation Example 6: Conversion to Lithium Sulfate and Lithium Carbonate Using Lithium Phosphate

For conversion to high-concentration lithium sulfate solution and lithium carbonate using lithium phosphate that was produced from the lithium-containing water-leaching solution, 125 g of lithium phosphate was mixed with 1 L of 1M sulfuric acid, resulting in the production of a high-concentration lithium sulfate solution. The lithium ion concentration in the high-concentration lithium sulfate solution was confirmed to be approximately 23,270 ppm.

During the carbonation reaction of the lithium solution, PO₄ anions from the lithium sulfate solution may reprecipitate as lithium phosphate when reacting with lithium ions during alkali titration and carbonation using Na₂CO₃. To remove PO₄ anions, Ca(OH)₂ was added, causing precipitation as Ca₃(PO₄)₂·xH₂O or similar compounds.

As shown in Table 4, during the impurity removal process, it was observed that as Ca(OH)₂ was added and the solution pH increased, lithium loss occurred.

TABLE 4

| | | Li (ppm) | pH |
|---|---|---|---|
| Lithium Sulfate Solution | | 23270 | 1.03 |
| Ca(OH)₂(g)/Lithium | 50 | 17760 | 5.01 |
| Sulfate Solution (L) | 100 | 9900 | 7.28 |
| Solid/Liquid Ratio | 150 | 13150 | 10.07 |
| | 200 | 14280 | 11.03 |

After separating the precipitate, Na₂CO₃ was added under conditions where the Li/Na₂CO₃ molar ratio was 2, resulting in the production of lithium carbonate. As shown in FIG. 9, the XRD pattern of the recovered product after the carbonation reaction was confirmed to be identical to that of lithium carbonate, verifying successful conversion.

The preparation examples described so far illustrate potential lithium loss points during lithium extraction and lithium carbonate production from low-grade lepidolite. The present disclosure aims to propose an efficient lithium recovery and lithium carbonate production technology to overcome these losses, as demonstrated in the exemplary embodiments.

In particular, according to the lithium recovery method of the present disclosure, lithium loss can be reduced during acid roasting and water leaching of lepidolite, by minimizing aluminum incorporation, which affects concentration and purification processes. In addition, the lithium recovery method of the present disclosure can also reduce lithium loss during the production of a high-concentration lithium solution from lithium phosphate, by optimizing sulfuric acid leaching and purification processes to improve lithium recovery efficiency.

### EXEMPLARY EMBODIMENTS

### Exemplary Embodiment 1: Lithium Component Separation Experiment from Low-Grade Lepidolite Powder (Calcination/Acid Roasting/Water Leaching)

In this exemplary embodiment, the experiment was conducted using lepidolite powder with the following composition: Li (0.46 wt %), Mg (0.19 wt %), Al (8.1 wt %), Ca (12.3 wt %), and Si (15.6 wt %).

In this experiment, lepidolite powder was calcined at 1000° C. for 60 minutes. The calcined lepidolite powder was then mixed with 1 M to 9 M sulfuric acid solution at a solid-to-liquid ratio of 1000 g/L, dried, and subsequently subjected to acid roasting at 300° C. for 30 minutes. To separate the lithium component from the acid-roasted conversion product, water leaching was performed using 3 g of acid-roasted conversion product mixed with 30 mL of water, under stirring conditions at 300 rpm for 24 hours. The resulting lithium-containing water-leaching solution was collected.

The experimental results are presented in Table 5.

TABLE 5

| Acid Roasting Stage | | | | | | | | | | | |
|---|---|---|---|---|---|---|---|---|---|---|---|
| | | Lithium | | | | | | | | | |
| Sulfuric | | Content | | | | | | | | | |
| Acid Molar | Sample | After | | | | | | | | | |
| Concentration | Weight | Roasting | Water Leaching Stage | | | | | | | | |
| (M) | (g) | (%) | Li | Na | K | Al | Mg | Ca | Si | Mn | Fe |
| 1 | 4.001 | 0.424 | 28.57 | 25.94 | 13.63 | — | — | 708 | 14.23 | — | — |
| 2 | 4.000 | 0.389 | 81.5 | 110.6 | 62 | — | 31.9 | 513 | 5.48 | 2.57 | — |
| 3 | 4.000 | 0.355 | 185.2 | 313.8 | 342.6 | 730 | 59.3 | 457.5 | 29.21 | 14.24 | — |
| 4 | 4.001 | 0.351 | 187.1 | 336.6 | 418 | 1012.5 | 61 | 473.5 | 33.8 | 14.96 | 1.71 |
| 5 | 4.000 | 0.326 | 228.2 | 488.9 | 701 | 2024 | 74.9 | 428.5 | 41.78 | 15.97 | 11.81 |
| 6 | 4.001 | 0.302 | 236.5 | 560.8 | 725.1 | 2912 | 83.1 | 441 | 185.5 | 16.08 | 52.54 |
| 7 | 4.001 | 0.297 | 203.7 | 460.6 | 562.9 | 2799 | 84.7 | 499 | 213.7 | 15.27 | 63.1 |
| 8 | 4.000 | 0.292 | 176 | 372.4 | 367 | 1902 | 69.1 | 540.5 | 203.3 | 13.56 | 48.05 |
| 9 | 3.999 | 0.288 | 169 | 337.6 | 495.7 | 1261 | 50.7 | 538 | 214.6 | 10.97 | 35.77 |

Referring to Table 5, it was observed that as the molar concentration of the sulfuric acid solution increased, the lithium ion concentration in the recovered solution also increased. However, at concentrations of 6 M or higher, the lithium ion concentration began to decrease.

This phenomenon is likely due to the fact that as the molar concentration of sulfuric acid increases, not only lithium but also other metal ions react to form sulfate compounds, which become incorporated into the solution. Consequently, the relative lithium content per unit weight decreases, leading to a reduction in the lithium ion concentration in the recovered solution.

### Exemplary Embodiment 2: Suppression of Aluminum Incorporation in the Leachate Through Post-Treatment of Acid-Roasted Conversion Products

During the calcination and acid-roasting process of low-grade lepidolite, the sulfuric acid solution used as a reactant forms sulfate compounds not only with lithium but also with other metal components. As a result, during the water-leaching process, not only lithium but also other metal components are incorporated into the leachate. In particular, aluminum poses a significant issue during the lithium concentration process (which involves repeated water leaching and high solid-to-liquid ratios), where lithium and aluminum can co-precipitate to form Li—Al LDH. This leads to lithium loss during the recovery process.

According to an exemplary embodiment of the present disclosure, to suppress the incorporation of aluminum sulfate components into the leachate, post-heat treatment was performed on the acid-roasted conversion products. In particular, lepidolite powder was calcined at 1000° C. for 60 minutes. Then, the calcined lepidolite powder was mixed with 6 M sulfuric acid solution (which had shown the highest lithium recovery rate from the results of acid roasting) at a solid-to-liquid ratio of 1000 g/L, dried, and subjected to acid roasting at 300° C. for 30 minutes. The resulting acid-roasted conversion product was then subjected to heat treatment at 500° C. to 900° C. for 4 hours. The heat-treated product was water-leached at a solid-to-liquid ratio of 100 g/L, and the lithium-containing water-leaching solution was recovered.

The experimental results are shown in Table 6 and FIG. 10.

TABLE 6

| Lepidolite | | | Water Leaching | |
|---|---|---|---|---|
| Calcination/ | | Post-Heat | (3 g/30 mL, 300RPM, | |
| Acid | Sample | Treatment | Room Temperature-24 h) | |
| Roasting | Weight | Conditions | Li conc. | Al conc. |
| Conditions | (g) | (° C.-h) | (ppm) | (ppm) |
| Lep.(1000° C., | 4.007 | 500-4 | 165.45 | 2125.59 |
| 1 h) + 6M H₂SO₄ | 4.004 | 600-4 | 167.23 | 1437.29 |
| (300° C.-30 m) | 4.005 | 700-4 | 251.16 | ND |
| | 4.002 | 800-4 | 188.89 | ND |
| | 4.005 | 900-4 | 184.44 | ND |

From the experimental results, it was observed that when the acid-roasted conversion product was heat-treated at 700° C. and then subjected to water leaching, the highest lithium ion concentration was obtained. In addition, aluminum incorporation into the leachate was effectively suppressed under these conditions.

### Exemplary Embodiment 3: Preparation of Lithium Concentrate After Acid Roasting and Heat Treatment of Lepidolite

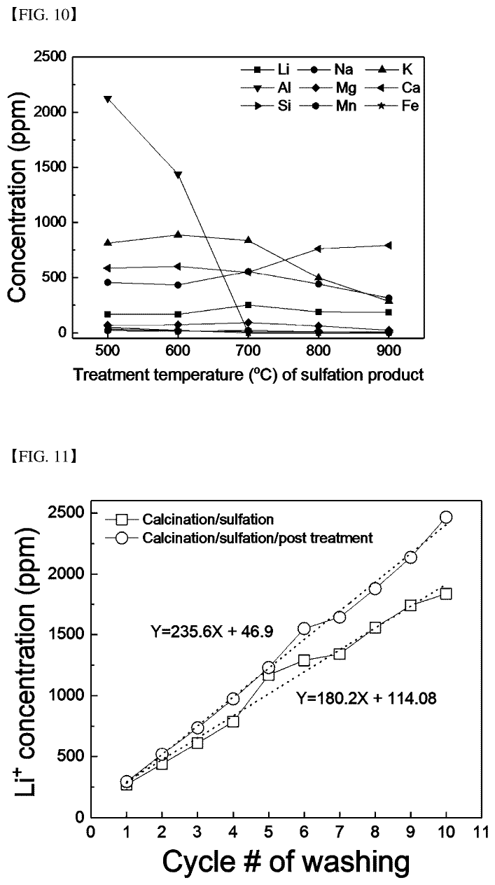

Lepidolite was calcined at 1000° C. for 1 hour, then subjected to acid roasting with 6 M sulfuric acid solution at a solid-to-liquid ratio of 1000 g/L. Afterward, the acid-roasted conversion product was heat-treated at 700° C. for 4 hours. To produce a lithium concentrate, the leachate was reused repeatedly, and the lithium ion concentration was analyzed based on the number of leaching cycles. The results are presented in Table 7 and FIG. 11.

TABLE 7

| Lepidolite | | | | Li conc. | |
|---|---|---|---|---|---|
| Calcination/ | Post-Heat | Water | | (ppm) | |
| Acid | Treatment | Leaching | Cycle # | Without | With |
| Roasting | Conditions | Conditions | of | Heat | Heat |
| Conditions | (° C.-h) | (g/L) | washing | Treatment | Treatment |
| Lep.(1000° C., | 700-4 | 100 | 1 | 272.37 | 294.80 |
| 1 h) + 6M | | | 2 | 438.97 | 519.37 |
| H₂SO₄ | | | 3 | 611.22 | 737.33 |
| (300° C.-30 m) | | | 4 | 788.24 | 974.53 |
| | | | 5 | 1170.35 | 1231.13 |
| | | | 6 | 1290.46 | 1549.78 |
| | | | 7 | 1342.22 | 1644.03 |
| | | | 8 | 1556.74 | 1879.95 |
| | | | 9 | 1743.85 | 2135.59 |
| | | | 10 | 1838.08 | 2465.24 |

During the water leaching process, the solid-to-liquid ratio (g/L) of the heat-treated acid-roasted conversion product (g) to water (L) was maintained at 100, and the leachate was reused for up to 10 cycles. As a result, when post-heat treatment was applied, the lithium ion concentration increased more significantly with repeated leaching cycles compared to the case where no heat treatment was applied. This indicates that post-heat treatment enhances lithium extraction efficiency, leading to higher lithium ion concentrations in the leachate across multiple cycles.

### Exemplary Embodiment 4: Preparation of Lithium-Containing Water-Leaching Solution After Acid Roasting and Heat Treatment of Lepidolite

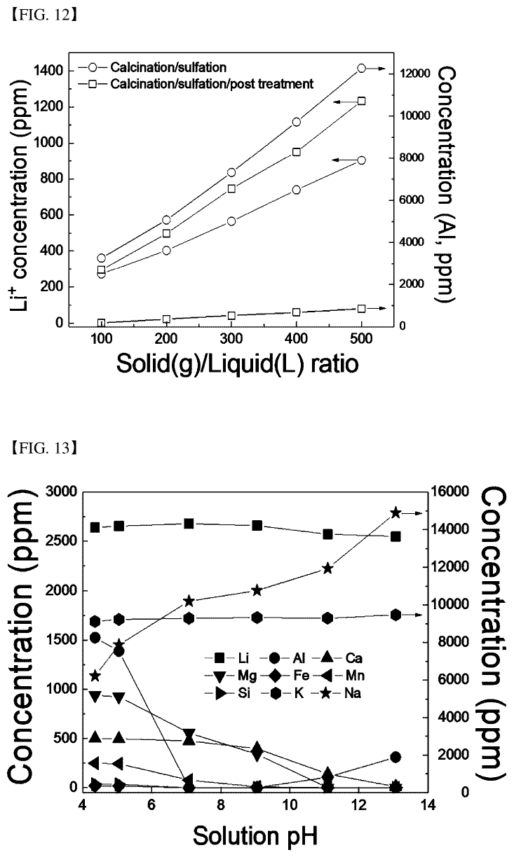

Lepidolite was calcined at 1000° C. for 1 hour, then subjected to acid roasting with 6 M sulfuric acid solution at a solid-to-liquid ratio of 1000 g/L. The acid-roasted conversion product was then heat-treated at 700° C. for 4 hours. To produce a lithium concentrate, during the water-leaching process, the solid-to-liquid ratio (g/L) of the heat-treated acid-roasted conversion product (g) to water (L) was adjusted within the range of 100 to 500, and the lithium ion concentration was analyzed accordingly. The experimental results are presented in Table 8 and FIG. 12.

TABLE 8

| | Water Leaching (×g/30 mL, 300RPM, Room Temperature-24 h) | | | | | | | | |
|---|---|---|---|---|---|---|---|---|---|
| Post-Heat | Solid-to- | | | | | | | | |
| Treatment | Liquid | Li | Na | K | Al | Mg | Ca | Si | Fe |
| Condition | Ratio | conc. | conc. | conc. | conc. | conc. | conc. | conc. | conc. |
| (° C.-h) | (g/L) | (ppm) | (ppm) | (ppm) | (ppm) | (ppm) | (ppm) | (ppm) | (ppm) |
| X | 100 | 272.37 | 555.33 | 910.25 | 3259.19 | 100.69 | 500.76 | 51.81 | 64.75 |
| | 200 | 404.274 | 711.285 | 1108.850 | 5069.009 | 147.719 | 456.414 | 118.492 | 138.908 |
| | 300 | 564.945 | 1041.245 | 1605.393 | 7318.161 | 207.551 | 475.101 | 167.509 | 263.241 |
| | 400 | 739.055 | 1395.933 | 2156.948 | 9726.796 | 283.135 | 470.344 | 194.088 | 384.080 |
| | 500 | 903.131 | 1795.634 | 2751.524 | 12270.468 | 350.630 | 470.590 | 220.428 | 486.077 |
| 700-4 | 100 | 294.80 | 586.0 | 802.58 | 181.95 | 91.85 | 518.87 | 3.17 | 2.46 |
| | 200 | 497.237 | 1046.821 | 1683.051 | 365.458 | 189.200 | 485.220 | 16.016 | 3.431 |
| | 300 | 746.335 | 1644.756 | 2569.357 | 534.680 | 294.233 | 417.960 | 20.778 | 6.121 |
| | 400 | 951.026 | 2194.047 | 3382.114 | 677.464 | 386.700 | 409.342 | 26.641 | 8.171 |
| | 500 | 1232.665 | 2922.755 | 4392.365 | 857.851 | 475.674 | 403.836 | 32.759 | 12.567 |

From the experimental results, the analysis of lithium ion concentration based on the solid-to-liquid ratio (g/L) of the heat-treated acid-roasted conversion product showed that higher lithium ion concentrations were observed in the heat-treated samples compared to those without post-heat treatment. In addition, during the water leaching process of the heat-treated acid-roasted conversion product, the amount of Al, Si, and Fe incorporated into the leachate was significantly reduced.

Furthermore, by applying post-heat treatment to the acid-roasted conversion product, the aluminum sulfate component formed after acid roasting was converted into aluminum hydroxide or aluminum oxide, effectively preventing its incorporation into the leachate during water leaching.

Thus, by post-heat treating the acid-roasted conversion product, the conversion of aluminum sulfate components to aluminum hydroxide or aluminum oxide helps to prevent aluminum contamination in the leachate, thereby significantly reducing lithium loss.

### Exemplary Embodiment 5: Purification Experiment of Lithium-Containing Water-Leaching Solution

Lepidolite was calcined at 1000° C. for 1 hour, acid-roasted with 6 M H₂SO₄, and heat-treated at 700° C. for 4 hours. After water leaching of the acid-roasted conversion product, the recovered lithium-containing leachate had a lithium ion concentration of approximately 2,462 ppm.

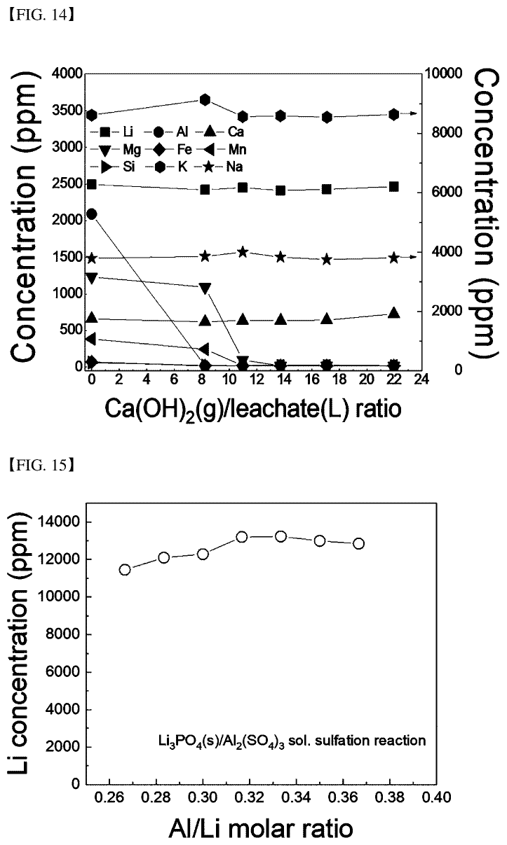

To separate impurities from the lithium-containing water-leaching solution, 50% NaOH solution and Ca(OH)₂ were added. The mixture was then stirred at 300 rpm at room temperature for 24 hours, and the distribution of impurities was analyzed based on solution pH and Ca(OH)₂ addition. The results are presented in Tables 9 to 11 and FIGS. 13 to 14.

### 1. Use of NaOH Solution

TABLE 9

| | NaOH | | Li | Al | Ca | Mg | Fe | Mn | Si | K | Na |
|---|---|---|---|---|---|---|---|---|---|---|---|
| | Volume | | conc. | conc. | conc. | conc. | conc. | conc. | conc. | conc. | conc. |
| | (mL) | pH | (ppm) | (ppm) | (ppm) | (ppm) | (ppm) | (ppm) | (ppm) | (ppm) | (ppm) |
| Initial | 0 | 4.36 | 2642.27 | 1524.71 | 501.95 | 937.69 | 19.1552 | 248.59 | 36.09 | 9127.04 | 6210.14 |
| pH 5 | 0.5 | 5.05 | 2655.12 | 1389.10 | 498.31 | 925.80 | 16.5748 | 243.57 | 34.19 | 9225.67 | 7875.98 |
| pH 7 | 1.1 | 7.08 | 2680.82 | 0.38 | 476.01 | 557.41 | N.D. | 78.02 | 1.15 | 9288.97 | 10195.63 |
| pH 9 | 1.72 | 9.05 | 2660.17 | 1.53 | 398.22 | 340.46 | N.D. | 9.35 | N.D. | 9329.55 | 10763.28 |
| pH 11 | 2.16 | 11.1 | 2572.59 | 108.08 | 139.84 | N.D. | N.D. | N.D. | N.D. | 9285.84 | 11936.58 |
| pH 13 | 3.26 | 12.07 | 2550.24 | 310.18 | 11.77 | N.D. | N.D. | N.D. | N.D. | 9470.44 | 14899.41 |

Referring to Table 9 and FIG. 13, it was observed that when NaOH solution was added to adjust the solution pH, the Al concentration decreased initially. However, when the pH increased to 9 or higher, the Al concentration increased again.

This suggests that under alkaline conditions, precipitated Al species can react with an excess of Na to form water-soluble sodium aluminate, leading to the observed increase in Al concentration. In addition, Mg, Mn, and Si were effectively removed at pH 11 and above.

Furthermore, during NaOH titration, a slight loss of lithium was observed at pH values 11 or higher. This is likely due to the formation of Li—Al LDH, where lithium reacts with aluminum species, leading to lithium precipitation and subsequent loss.

### 2. Use of Ca(OH)₂

To minimize lithium loss during the purification process, Ca(OH)₂ was added as an optimized method to efficiently separate aluminum impurities.

Lepidolite was calcined at 1000° C. for 1 hour, acid-roasted with 6 M H₂SO₄, and heat-treated at 700° C. for 4 hours. After water leaching of the acid-roasted conversion product, the recovered lithium-containing leachate had a lithium ion concentration of approximately 2,462 ppm.

To separate impurities from the lithium-containing water-leaching solution, Ca(OH)₂ was added. The distribution of impurities was analyzed based on the amount of Ca(OH)₂ addition. The results are presented in Tables 10 to 11 and FIG. 14.

TABLE 10

| Ca(OH)₂(g)/ | | | | | | | | | |
|---|---|---|---|---|---|---|---|---|---|
| Water-Leaching | | | | | | | | | |
| Solution (L) | Li | Al | Ca | Mg | Fe | Mn | Si | K | Na |
| Solid-to-Liquid | conc. | conc. | conc. | conc. | conc. | conc. | conc. | conc. | conc. |
| Ratio | (ppm) | (ppm) | (ppm) | (ppm) | (ppm) | (ppm) | (ppm) | (ppm) | (ppm) |
| initial | 2494.15 | 1562.12 | 483.99 | 916.95 | 39.51 | 276.16 | 32.80 | 8614.88 | 6075.92 |
| 8.24 | 2421.95 | 0.43 | 451.97 | 811.09 | N.D. | 170.41 | 4.23 | 9133.11 | 6175.22 |
| 10.98 | 2451.95 | 0.91 | 466.91 | 60.41 | N.D. | 1.69 | N.D. | 8566.38 | 6404.07 |
| 13.72 | 2411.83 | 6.84 | 466.48 | N.D. | N.D. | N.D. | N.D. | 8594.24 | 6140.26 |
| 17.08 | 2429.41 | 7.78 | 470.19 | N.D. | N.D. | N.D. | N.D. | 8549.37 | 6001.62 |
| 21.96 | 2462.81 | 0.42 | 533.66 | N.D. | N.D. | N.D. | N.D. | 8639.22 | 6108.20 |

TABLE 11

| | Li | Al | Ca | Mg | Fe | Mn | Si | K | Na |
|---|---|---|---|---|---|---|---|---|---|
| | conc. | conc. | conc. | conc. | conc. | conc. | conc. | conc. | conc. |
| pH | (ppm) | (ppm) | (ppm) | (ppm) | (ppm) | (ppm) | (ppm) | (ppm) | (ppm) |
| 12.1 | 2411.83 | 6.84 | 466.48 | N.D. | N.D. | N.D. | N.D. | 8594.24 | 6140.26 |
| 13 | 2457.34 | N.D. | 26.73 | N.D. | N.D. | N.D. | N.D. | 9321.20 | 8643.36 |

By adding Ca(OH)₂ at different solid-to-liquid ratios, it was observed that at a solid-to-liquid ratio of approximately 13 or higher, more than 99 wt % of impurities were removed, excluding Ca and monovalent ions.

Additionally, referring to Table 11, it was confirmed that residual Ca ions could be removed by over 95 wt % when the solution pH was increased to approximately 13 using NaOH. Furthermore, since Ca ions can be easily removed during the production of lithium phosphate (Li₃PO₄) or high-concentration lithium solutions, it was determined that removing Ca at this stage is not essential.

### Exemplary Embodiment 6: Production of Lithium Phosphate from Purified Lithium-Containing Water-Leaching Solution

Lepidolite was calcined at 1000° C. for 1 hour, acid-roasted with 6 M H₂SO₄, and heat-treated at 700° C. for 4 hours. After water leaching of the acid-roasted conversion product, the recovered lithium-containing leachate had a lithium ion concentration of approximately 2,450 ppm. To produce a high-concentration lithium solution, lithium phosphate (Li₃PO₄) was synthesized as an intermediate compound from the lithium-containing water-leaching solution.

For this, NaOH and phosphoric acid (H₃PO₄) solutions were added to the lithium-containing water-leaching solution, under the condition where each of Li/PO₄ and Na/PO₄ molar ratio is 3. The mixture was then reacted for 24 hours. After the reaction was completed, the composition and concentration of residual ions were analyzed, as shown in Table 12. The results indicated that the lithium ion recovery rate was approximately 82 wt %.

TABLE 12

| | Li | Li | Al | Ca | Mg | Fe | Mn | Si | K | Na |
|---|---|---|---|---|---|---|---|---|---|---|
| Reaction | conc. | Conversion | conc. | conc. | conc. | conc. | conc. | conc. | conc. | conc. |
| Time (h) | (ppm) | Rate (%) | (ppm) | (ppm) | (ppm) | (ppm) | (ppm) | (ppm) | (ppm) | (ppm) |
| Initial | 2457.34 | — | N.D. | 26.73 | N.D. | N.D. | N.D. | N.D. | 9321.20 | 8643.36 |
| 12 h | 583.11 | 76.27 | N.D. | N.D. | N.D. | N.D. | N.D. | N.D. | 8143.46 | 19248.55 |
| 24 h | 445.8543 | 81.86 | N.D. | N.D. | N.D. | N.D. | N.D. | N.D. | 7956.134 | 18898.66 |

### Exemplary Embodiment 7: Production of High-Concentration Lithium Sulfate Solution from Lithium Phosphate

The production of lithium carbonate typically involves reacting a high-concentration lithium solution with a carbonate compound, leading to the precipitation of lithium carbonate due to its low solubility.

For efficient lithium carbonate production, a high-concentration lithium solution is required. However, as observed in Preparation Example 6, when lithium phosphate was leached with sulfuric acid to produce a high-concentration lithium solution, lithium loss occurred during the conversion process to lithium carbonate.

To address this issue, in the present disclosure, a high-concentration lithium sulfate solution was produced by substituting lithium phosphate with sulfate compound (Me-SO₄). MgSO₄, (NH₄)₂SO₄, and Al₂(SO₄)₃ were used as the sulfate compound, and the conversion reaction was conducted under conditions maintaining a Li/SO₄ molar ratio of 2, at a temperature of 80° C.

Lithium phosphate (g) and sulfate compound solution (L) with the sulfate compound dissolved in distilled water were mixed at a solid-to-liquid ratio of 100. In order to prevent the evaporation of the aqueous solution during the reaction, a reflux reactor was used.

Referring to Table 13, when Al₂(SO₄)₃ was used as the sulfate compound at the same solid-to-liquid ratio (100), it was observed the highest lithium concentration in the solution.

TABLE 13
Conversion of Li₃PO₄ to Li₂SO₄ solution

| Experimental Conditions | | | | | | |
|---|---|---|---|---|---|---|
| | | Solid-to- | | Reaction | | |
| | Molar | Liquid | Stirring | Temperature/ | | Concentration |
| Sulfate | Ratio | Ratio | Speed | Reaction | Sample | (ppm) |
| Source | (Li/Metal) | (g/L) | (r.p.m.) | Time | Name | Li |
| MgSO₄ | 2/1 | 100/1 | 300 | 80° C., 8 hr | Initial | |
| | | | | | Final | 7993.99 |
| (NH₄)₂SO₄ | 1/1 | 100/1 | 300 | 80° C., 8 hr | Initial | |
| | | | | | Final | 2796.43 |
| Al₂(SO₄)₃ | 3/1 | 100/1 | 300 | 80° C., 8 hr | Initial | |
| | | | | | Final | 13224.2 |

In addition, referring to FIG. 15, when Al₂(SO₄)₃ was used, it was observed that a high lithium ion concentration was achieved within an Al/Li molar ratio range of 0.317 to 0.367.

Furthermore, at the stoichiometric ratio of 0.333, the highest lithium concentration (13224.2 ppm) was achieved.

### Exemplary Embodiment 8: Production of Lithium Carbonate from High-Concentration Lithium Sulfate Solution

Lithium phosphate (Li₃PO₄) and aluminum sulfate (Al₂(SO₄)₃) solution were reacted under the conditions where the solid-to-liquid ratio is 220 and the Al/Li molar ratio is 0.333 at a reaction temperature of 80° C. for the reaction time of 8 hours. Then, in order to remove unreacted aluminum (Al) and phosphate (PO₄) components from the recovered lithium sulfate solution, Ca(OH)₂ was added to the lithium sulfate solution such that a solid-to-liquid ratio of Ca(OH)₂ (g) to lithium sulfate solution (L) becomes 100 g/L.

After adding Ca(OH)₂, Al and PO₄ impurities were precipitated and removed. Subsequently, in order to remove residual Ca ions from the filtrate, 50% NaOH solution was added until the pH reached approximately 12.

After separation of impurities, in order to prepare lithium carbonate, sodium carbonate was added to the purified lithium sulfate solution such that Li/CO₃ molar ration becomes 2. The mixture was stirred at 60° C. for 8 hours, followed by the separation of precipitated lithium carbonate. As a result, Referring to Table 14, the lithium conversion efficiency reached 92.86 wt %.

TABLE 14

| Purified | Reaction | | | | Li |
|---|---|---|---|---|---|
| Solution | Temperature - | Stirring | Li/CO₃ | Li | Conversion |
| Volume | Reaction Time | Speed | Molar | conc. | Efficiency |
| (mL) | (° C.-h) | (RPM) | Ratio | (ppm) | (%) |
| 340 | 60-8 | 300 | 2 | 25031.985 | 92.8596 |
| | | | | 1787.386 | |

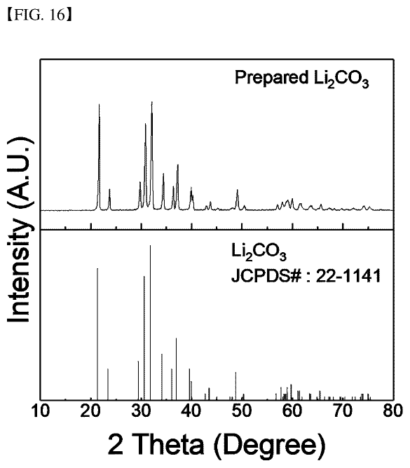

In addition, referring to FIG. 16, the XRD pattern of the recovered precipitate confirms the formation of lithium carbonate (Li₂CO₃).

In the above, exemplary embodiments of the method for recovering lithium with high efficiency from low-grade lithium minerals through process improvement and the lithium carbonate prepared thereby according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

### INDUSTRIAL APPLICABILITY

The present disclosure can be applied to a method for recovering lithium with high efficiency from low-grade lithium minerals.

1. A method for recovering lithium with high efficiency from low-grade lithium minerals through process improvement, the method comprising:
a step (S10) for acid-roasting a lithium-containing mineral to form an acid-roasted conversion product that is an oxide of constituent metal of the lithium-containing mineral;
a step (S20) for heat-treating the acid-roasted conversion product;
a step (S30) for water-leaching the heat-treated acid-roasted conversion product to prepare a lithium-containing water-leaching solution;
a step (S40) for adding an alkali solvent to the lithium-containing water-leaching solution to precipitate and remove impurities, wherein the impurities includes Al, Mg, Fe, Mn, and Si, while excluding lithium; and
a step (S50) for preparing at least one selected from a group consisting of lithium phosphate, lithium sulfate, and lithium carbonate, from the lithium-containing water-leaching solution removed of the impurities,
wherein, in the step (S10), the acid-roasting is performed by mixing the lithium-containing mineral with an acid solution, drying a mixture of the lithium-containing mineral and the acid solution, and then heating the mixture.

2. The method of claim 1, further comprising:
a step for calcining the lithium-containing mineral at a temperature of 850° C. to 1200° C. for 30 to 90 minutes, before acid-roasting the lithium-containing mineral.

3. The method of claim 1,
wherein the lithium-containing mineral has a lithium content ranging from 0.1 wt % to 1.5 wt %.

4. The method of claim 1,
wherein the lithium-containing mineral includes at least one selected from a group consisting of low-grade lepidolite and spodumene.

5. The method of claim 1,
wherein the step (S10) comprises:
mixing the lithium-containing mineral with a sulfuric acid solution having a concentration of 5 M to 7 M or 11 M to 12 M, such that a mass ratio (g/L) of the lithium-containing mineral to the sulfuric acid solution ranges from 800 to 1200; and
after drying, performing sulfuric acid-roasting at a temperature of 200° C. to 500° C. for 10 to 60 minutes.

6. The method of claim 1,
wherein in the step (S20), the acid-roasted conversion product is heat-treated at a temperature of 500° C. to 900° C. for 1 to 7 hours, thereby converting an aluminum sulfate component formed after the acid-roasting into an aluminum hydroxide component or an aluminum oxide component, to suppress incorporation into a leachate during the water-leaching.

7. The method of claim 1,
wherein in the step (S30), a mass ratio (g/L) of the heat-treated acid-roasted conversion product to water ranges from 50 to 700.

8. The method of claim 1,
wherein the alkali solvent includes at least one selected from a group consisting of sodium hydroxide, calcium hydroxide, and potassium hydroxide.

9. The method of claim 1,
wherein in the step (S40), the calcium hydroxide is added to the lithium-containing water-leaching solution such that a mass ratio (g/L) of the calcium hydroxide to the lithium-containing water-leaching solution ranges from 8 to 25.

10. The method of claim 8,
wherein in the step (S40), a sodium hydroxide solution is added to the lithium-containing water-leaching solution to adjust pH to a range of 7 to 11.

11. The method of claim 1,
wherein the step (S50) comprises:
a step (S51) for preparing lithium phosphate from the lithium-containing water-leaching solution removed of the impurities;
a step (S52) for preparing a lithium sulfate solution from the lithium phosphate; and
a step (S53) for preparing lithium carbonate from the lithium sulfate solution.

12. The method of claim 11,
wherein in the step (S51), a phosphate source and a sodium source are added to the lithium-containing water-leaching solution such that Li/PO₄ and Na/PO₄ molar ratios each range from 2 to 4, and a reaction is carried out for 10 to 30 hours.

13. The method of claim 11,
wherein in the step (S52), the lithium phosphate is mixed with a sulfate compound (Me-SO₄) solution dissolved in distilled water such that a mass ratio (g/L) of the lithium phosphate to the sulfate compound (Me-SO₄) solution ranges from 80 to 250, and a reaction is carried out at a temperature of 60° C. to 95° C. for 5 to 10 hours.

14. The method of claim 13,
wherein the sulfate compound includes at least one selected from a group consisting of magnesium sulfate (MgSO₄), ammonium sulfate ((NH₄)₂SO₄), and aluminum sulfate (Al₂(SO₄)₃).

15. The method of claim 14,
wherein in the step (S52), the aluminum sulfate (Al₂(SO₄)₃) is dissolved in distilled water to adjust Li/Al molar ratio to a range of 0.317 to 0.367.

16. The method of claim 11,
wherein the step (S53) comprises:
adding an alkali solvent to the lithium sulfate solution to remove impurities; and
adding a carbonate source to the lithium sulfate solution removed of the impurities to recover lithium carbonate.

17. The method of claim 16,
wherein in the step for adding an alkali solvent to the lithium sulfate solution to remove impurities,
calcium hydroxide is added to the lithium sulfate solution to precipitate and remove at least one selected from Al and PO₄, and
sodium hydroxide is added to adjust pH to 10 or higher to remove calcium ions.

18. The method of claim 16,
wherein in the step for adding a carbonate source to the lithium sulfate solution removed of the impurities to recover lithium carbonate,
the carbonate source is added to the lithium sulfate solution removed of the impurities such that Li/CO₃ molar ratio ranges from 1.5 to 2.5, and
the lithium sulfate solution removed of the impurities is stirred at a temperature of 50° C. to 70° C. for 6 to 10 hours to precipitate lithium carbonate.

19. The method of claim 16,
wherein the carbonate source includes at least one selected from a group consisting of sodium carbonate (Na₂CO₃), sodium bicarbonate (NaHCO₃), potassium carbonate (K₂CO₃), potassium bicarbonate (KHCO₃), calcium carbonate (CaCO₃), magnesium carbonate (MgCO₃), and barium carbonate (BaCO₃).

20. Lithium carbonate prepared by the method according to claim 1.
